(19) United States
(12) Patent Application Publication
(10) Pub. No.: US 2020/0341180 A1
(43) Pub. Date: Oct. 29, 2020

(54) LIGHT DIRECTING ARTICLE WITH A CONFORMAL RETARDER

(71) Applicant: 3M INNOVATIVE PROPERTIES COMPANY, St. Paul, MN (US)

(72) Inventors: Kui CHEN-HO, Woodbury, MN (US); Michael A. MCCOY, St. Paul, MN (US); John A. WHEATLEY, Stillwater, MN (US); Susannah C. CLEAR, Hastings, MN (US); Michelle L. TOY, North St. Paul, MN (US); Alex P. PONGRATZ, Minneapolis, MN (US); Matthew E. SOUSA, Rosemount, MN (US); Matthew B. JOHNSON, Woodbury, MN (US); Gilles BENOIT, Minneapolis, MN (US); David J.W. AASTUEN, Shoreview, MN (US); Guanglei DU, Painted Post, NY (US); Tien Yi T.H. WHITING, St. Paul, MN (US); Kevin W. GOTRIK, Hudson, WI (US); Christopher A. MERTON, St. Louis Park, MN (US); Ying XIA, Woodbury, MN (US); Olester BENSON, JR., Woodbury, MN (US); Charles A. SHAKLEE, Somerset, WI (US); Travis L. POTTS, Woodbury, MN (US); Carla S. THOMAS, Woodbury, MN (US)

(21) Appl. No.: 16/757,898

(22) PCT Filed: Oct. 26, 2018
(86) PCT No.: PCT/IB2018/058406

§ 371 Date: Apr. 21, 2020

Related U.S. Application Data
(60) Provisional application No. 62/578,191, filed on Oct. 27, 2017.
(60) Provisional application No. 62/610,180, filed on Dec. 23, 2017.

(51) Int. Cl. G02B 5/30; G02B 5/124; G02B 5/128

(52) U.S. Cl. CPC G02B 5/3083; G02B 5/128; G02B 5/124

(57) ABSTRACT

The disclosed light directing article has an optical element and a conformal retarder with predefined thickness that contours with the optical element. In one aspect, the light directing article is a retroreflective article, which further comprises a phase reversing optical reflector.

### TECHNICAL FIELD

The present disclosure relates to a light directing article with a conformal retarder.

### BACKGROUND

Light directing articles have an ability to manipulate incoming light and typically include an optical element such as a bead or prism. Retroreflective articles are light directing articles that include at least a retroreflecting element. Retroreflective elements reflect incident light back towards the light source. Retroreflecting elements include cube-corner prismatic retroreflectors and beaded retroreflectors. Retarders slow one of the orthogonal components of an incident propagating electromagnetic wave more than the other orthogonal components, creating a phase difference resulting in a change—for polarized incident light—in polarization state.

### SUMMARY

In one aspect, the present description relates to light directing articles having an optical element and a conformal retarder with predetermined thickness that contours with the optical element. In one aspect, the conformal retarder is a substantially uniform thickness. In one aspect, the light directing article is a retroreflective article, which further comprises a phase reversing optical reflector.

In one embodiment, the optical element comprises a bead, prism, or cube corner. In one embodiment, the phase reversing optical reflector comprises a metalized layer or a dielectric stack.

In one embodiment, the conformal retarder is in direct contact with the optical element. In one embodiment, the conformal retarder contacts only a portion of the optical element. In one embodiment, the conformal retarder contacts more than 5% and less than 100% of the optical element. In one embodiment, the conformal retarder is positioned between the optical element and the phase reversing optical reflector. In one embodiment, the conformal retarder is visibly transparent

In one embodiment, the phase reversing optical reflector is adjacent the optical element and the conformal retarder is positioned opposite the phase reversing optical reflector.

In one embodiment, the conformal retarder is patterned to include at least a first retarder region with a first retarder property and a second retarder region with a second retarder property, that is different than the first retarder property. In one embodiment, the first retarder region is a quarter wave retarder for at least one wavelength in the near infrared range and the second retarder region for the at least one wavelength, has substantially zero retardance or absorbs the at least one wavelength in the near infrared range.

In one embodiment, the light directing article further comprises a plurality of optical elements forming a first region of optical elements with the conformal retarder and a second region of optical elements without the conformal retarder. In one embodiment, the conformal retarder substantially continuously contours with the optical elements at the first region of optical elements. In one embodiment, the conformal retarder discontinuously contours with each of the optical elements at the first region of optical elements.

In one embodiment, the light directing article further comprises a protecting layer at an outermost surface of the light directing article and wherein the conformal retarder is positioned between the protective layer and the phase reversing optical reflector. In one embodiment, the light directing articles comprises a protecting layer at an outermost surface of the light directing article and wherein the conformal retarder is positioned between the protective layer and the optical element.

In one embodiment, a method of making a light directing article comprises applying a uniform thickness of a conformal retarder to an optical element. In one embodiment, the method further comprises applying the conformal retarder continuously to a plurality of optical elements. In one embodiment, the method further comprises applying the conformal retarder discontinuously to a plurality of optical elements. In one embodiment, the method comprises applying a transfer article comprising the conformal retarder and a release layer to the optical element.

Throughout this disclosure, the term “substantially,” when used to modify another term, should be understood to mean the magnitude of the property associated with the term can vary +/−5% of the true value of the property. For example, a retarder of a substantially uniform thickness refers to a retarder that has a thickness that can vary up to +/−5% at any given point along its length from the thickness of a retarder of a uniform thickness.

### BRIEF DESCRIPTION OF DRAWINGS

FIG. 1 is a side elevation schematic of a retroreflecting article;

FIG. 2 is a cross sectional side view of a first embodiment of a retroreflecting article with a conformal retarder;

FIG. 3 is a cross sectional side view of another embodiment of a retroreflecting article with a conformal retarder;

FIG. 4 is a cross sectional side view of another embodiment of a light directing article with a conformal retarder;

FIG. 5 is a cross sectional side view of another embodiment of a retroreflecting article with a conformal retarder;

FIG. 6 is a cross sectional side view of another embodiment of a retroreflecting article with a conformal retarder;

FIG. 7 is a cross sectional side view of another embodiment of a retroreflecting article with a conformal retarder;

FIG. 8 is a cross section side view of another embodiment of a retroreflective article with a conformal retarder.

FIG. 9 is a cross sectional view of an embodiment of a transfer article with a conformal retarder;

FIG. 10 is a retroreflecting article with a patterned arrangement of a conformal retarder;

FIG. 11 is a top view depiction of a light directing article with polarization and/or wavelength properties that vary spatially in a repeating pattern.

While the above-identified drawings and figures set forth embodiments of the invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of this invention. The figures may not be drawn to scale.

### DETAILED DESCRIPTION

Light directing articles and retroreflecting articles like the ones described herein may be useful in certain machine vision detection and sensing systems. As one example, as transportation infrastructure becomes more complicated, vehicles are gaining more driving autonomy. To navigate safely and effectively, sensing modules are increasingly incorporated into these vehicles to perform tasks from parking assistance, self-regulating cruise control and lane deviation warning, to fully autonomous navigation and driving, including collision avoidance and traffic sign interpretation.

To sense the world around them, vehicles use a set of sensors that emit one or more points of light. For example, a lidar (light detection and ranging) system may use a constellation of points of light that move through the environment to detect potential obstacles or informational objects. These interrogating light beams may use a narrow wavelength band, for example, 2-20 nm, or may use a broad wavelength band, for example, 100 nm or more.

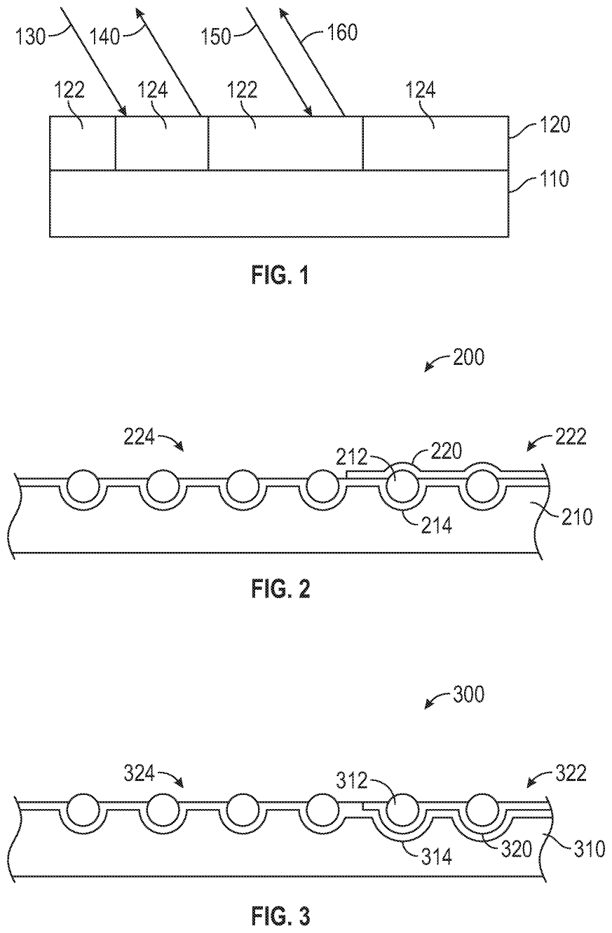

FIG. 1 is a side elevation schematic of a light directing article 100, specifically a retroreflecting article, with a conformal retarder 120. Specific arrangements of the conformal retarder 120 on the light directing layer will be described in more detail in FIGS. 3-8.

Retroreflecting article 100 includes retroreflecting layer 110 and conformal retarder 120. The retroreflecting article 100 has first regions 122 and second regions 124. First incident ray 130 and first retroreflected ray 140 and second incident ray 150 and second retroreflected ray 160 illustrate the general functionality of the retroreflecting article. Although here the conformal retarder 120 is shown as continuous forming first region 122 and second region 124, this is for purposes of description of the function of the conformal retarder 120. In other embodiments, the conformal retarder 120 may be only at a first region 122 or only at a second region 124 of the retroreflecting article 100 such that portions of the retroreflecting layer 110 are not covered with any portion of conformal retarder 120. In yet another embodiment, the conformal retarder 120 in a first region 122 may be for at least one wavelength range, and the conformal retarder 120 in a second region 124 may be for at least a different wavelength range. In other embodiments, the conformal retarder 120 in a first region 122 may be for wavelength in the near infrared range, and the conformal retarder 120 in a second region 124 may be for a different wavelength range, and has substantially zero retardance or absorbs the at least one wavelength in the near infrared range.

As an example, first incident ray 130 and second incident ray 150 may each be considered to be left-hand circularly polarized light. First incident ray 130 and second incident ray 150 are each incident on regions of retroreflecting article 100, in particular, on regions of conformal retarder 120 having different retardation properties. For the purposes of this example, it is assumed that retroreflecting layer 110 has the property of being circular polarization flipping (though not depolarizing); for example, left-hand circularly polarized light is converted to right-hand circularly polarized light, but linearly polarized light is not converted to light having an orthogonal polarization orientation. Further, it is assumed that conformal retarder 120 is configured at least in some regions as a quarter wave retarder, at least for the wavelength of the incident rays and at their incident angles.

First incident ray 130 is incident on a region of conformal retarder 120 configured as a quarter wave retarder, is converted from left-hand circularly polarized light to linearly polarized light, and is preserved in its linearly polarized state while retroreflecting. Upon repassing through conformal retarder 120, it is converted back into circularly polarized light having the same handedness as the incident light. A detector passing left-hand circularly polarized light would detect first retroreflected ray 140.

Second incident ray 150 is incident on a region of conformal retarder 120 that has substantially zero retardance for the wavelength region of the incident ray (for a given wavelength of interest has a retardance of less than λ/100). Second incident ray is not converted to linearly polarized light and so has its handedness flipped when retroreflected by retroreflecting layer 110. Second retroreflected ray 160 is right-hand circularly polarized light and therefore for the same detector as described before—a detector passing left-hand circularly polarized light—second retroreflected ray 160 would not be detected.

As shown in FIG. 10, the first region 122, which contains the conformal retarder 120, would return light and appear bright, while the second region 124 (in this embodiment, which does not have any conformal retarder 120), would appear dark, providing contrast between first region 122 and second region 124.

Light directing layer 110 may be any suitable layer or combination of layers for directing incident light. In embodiments where the light directing layer is a retroreflecting layer 110, the retroreflecting layer may be any suitable retroreflector that does not substantially depolarize polarized light. Suitable retroreflectors include optical elements and a phase reversing optical reflector.

For example, suitable retroreflectors include substantially non-depolarizing retroreflectors. For example, a non-depolarizing retroreflector retroreflects an incident left-handed circularly polarized light to either a left-handed circularly polarized light or a right-handed circularly polarized light. Depending on the application, some degree of depolarization may be acceptable and to some degree is inevitable based on spatial non-uniformities, from real-world manufacturing conditions, or otherwise. Depolarization may also be dependent to some degree on the angle of incidence for polarized light or the wavelength of the incident polarized light. In many cases, however, and for the purposes of this description, depolarizing retroreflectors neither flip nor maintain the polarization of incident polarized light. For example, incident left-handed circularly polarized light may return a small portion of left-handed circularly polarized light as part of a larger generally randomized polarization. In other examples using depolarizing retroreflectors, incident left-handed circularly polarized light may be returned as elliptically polarized light or substantially non-polarized light. Again, for the purposes of this description, these types of retroreflectors should not be considered non-depolarizing retroreflectors.

Suitable retroreflectors that do not depolarize polarized light (at least to a degree potentially applicable for the current description) and include a phase reversing optical reflector with the optical element, include, for example, a metal-backed prism (cube-corner) retroreflectors, metal-backed beaded retroreflectors, and beaded retroreflectors partially immersed in binder optionally including, for example, nacreous or other reflective flake material. Metal or a dielectric stack may be used with a prism or a bead for achieving retroreflection that does not depolarize polarized light. Air-backed prisms that rely on total-internal reflection to retroreflect incident light were observed to depolarize incident light.

The retroreflecting layer may be any suitable size and have any suitable size optical elements. For example, prisms or beads used in the retroreflecting layer may be on the order of several micrometers in size (width or diameter), tens of micrometers in size, hundreds of micrometers in size, or several millimeters in size, or even several centimeters in size. Beads of multiple different sizes and size distributions may be utilized as appropriate and suitable for the application. Depending on the retroreflected wavelength of interest, there may be a certain practical minimum feature size in order to prevent diffractive and other sub-wavelength feature effects from influencing or even dominating the desired optical performance.

For beaded retroreflectors, glass beads are commonly used, but any substantially spherical and substantially transparent material can be used. Other examples of bead materials include nanocrystalline ceramic oxides. The materials may be selected based on durability, environmental robustness, manufacturability, index of refraction, wavelength transparency, coatability, or any other physical, optical, or material property. The beads may be partially submerged into a reflective binder, containing, for example, nacreous or metal flake, or they may be partially metallized through vapor coating, sputter coating, or any other suitable process. In some embodiments, the beads may be coated with a dielectric material. In some embodiments, a metalized or dielectric mirror containing film may be laminated or otherwise attached to the bead surface. In some embodiments, the coating or layer may be a spectrally selective reflector. In some embodiments, beads may create an optical path, through a non-reflective binder, between the light incident surface of a retroreflector and the optical reflector. The non-reflective binder may have any physical properties and may impart certain desired properties to the retroreflecting layer. For example, the binder may include a pigment or dye to impart wavelength selective absorption, which can optionally provide a colored effect to the retroreflective article.

For prismatic retroreflectors, any suitable prismatic shape may be microreplicated or otherwise formed in a transparent (at least transparent to the wavelength of interest) medium. For example, right angle linear prisms, such as those in Brightness Enhancing Film (BEF), may be used, although such prism would not be retroreflecting over a very wide range of angles. Microstructures with a cube corner, such as a truncated cube or a full cube, are widely used as a retroreflecting prismatic shape, where each incident light ray is reflected three times before being returned to the incident direction. Other surfaces having more facets may be used as a prismatic retroreflector. Any suitable resins may be used; thermoplastic material or resins that may be applied in a liquid or flowable form and then subsequently cured and removed from a tool may be used. The tool can be formed through any suitable process, including etching (chemical or reactive ion etching), diamond turning, and others. In some embodiments, the tool can be a fused or otherwise attached collection of multiple parts to cover a full prismatic sheet surface pattern. Curing may take place through the addition of heat or electromagnetic radiation. UV-curable resins or resins that are curable through atypical ambient conditions may be chosen as to not unintentionally partially or fully cure during handling or pre-cure processing. In some embodiments, additive or subtractive manufacturing processes may be used to form either a tool surface for microreplication or the prismatic surface itself.

Conformal retarder 120 has substantially uniform thickness and contours with at least a portion of the optical element. Uniform thickness is a thickness having general uniformity within manufacturing tolerances and may include situations with the retarder might ripple, crack, crimp, fold onto itself. In one embodiment, the conformal retarder 120 is in direct contact with the optical element. In one embodiment, additional layers or materials are adjacent to the conformal retarder 120 and positioned between the conformal retarder 120 and the optical element, such as, for example, adhesives, primers, or interlayers. As will be shown in the figures, the conformal retarder 120 contours with at least a portion of the optical element. In some cases, the conformal retarder 120 covers less than the entire surface of the optical element. For example, in one embodiment, the conformal retarder contacts more than 5% and less than 100% of the optical element.

In one embodiment, additional layers or materials may be adjacent to the conformal retarder 120 and positioned between the conformal retarder and the non-depolarizing optical reflector, such as, for example, adhesive, primer, interlayer, color layer, acrylate layer. These additional layers desirably would not interfere with the properties of the incoming and outgoing light. The additional layer can contact more than 5% and less than 100% of the conformal retarder 120. In some embodiments, the additional layer between the conformal retarder and the non-depolarizing optical reflector can cover the entire contact area of the conformal retarder 120 and the optical element.

Conformal retarder 120 may be any suitable retardation layer that selectively slows one of the orthogonal components of light to change its polarization. In some embodiments, conformal retarder 120 may be configured as a quarter wave retarder. A quarter wave retarder has a retardance that, for a certain wavelength of interest λ, has a retardance of λ/4. A quarter wave retarder for a given wavelength of light will convert it from circularly polarized light to linear polarized light or vice versa. In some applications, a quarter wave retarder may function acceptably without having perfect λ/4 retardance. For some applications, using an achromatic retarder may permit substantially quarter wave retardance (i.e., within 5% of true quarter wave retardance) to be maintained over a range of wavelengths; for example, a range of wavelengths spanning 2 nm, 10 nm, 20 nm, 40 nm, 50 nm, 100 nm, 150 nm, 200 nm, 300 nm, 400 nm, or even 500 nm. In some embodiments, the quarter wave retarder has substantially quarter wave retardance over the entire near-infrared wavelength range, for example, 700 to 1400 nm. In some embodiments, the quarter wave retarder has substantially quarter wave retardance over the entire visible wavelength range, for example, 400 to 700 nm. In some embodiments, the quarter wave retarder has substantially quarter wave retardance over both the near-infrared and visible range.

In some embodiments, conformal retarder 120 may provide substantially similar retardance values over a wide range of incidence angles. In some embodiments, the retardance may not vary by more than 10% over a 30 degree half-angle cone, may not vary by more than 10% over a 45 degree half-angle cone, or may not vary by more than 10% over a 60 degree half-angle cone. For some applications, not varying more than 20% over a 30, 45, or 60 degree half angle cone may be acceptable.

Conformal retarder 120 may include any suitable retarding material or materials. In some embodiments, retardation layer 120 includes or is a liquid crystal retarder. In some embodiments, conformal retarder 120 includes an oriented birefringent polymer film. Depending on the birefringence of the chosen polymer set, suitable thickness may be chosen in order to obtain the desired retardance values. In some embodiments, conformal retarder 120 may include a compensation film or other additional film with low retardance (for example, less than 100 nm of retardance) in order to enhance or preserve circularly polarized light over a wide range of angles for a wavelength or wavelength range of interest. As will be described in more detail below with respect to FIGS. 2-8, the conformal retarder 120 contours with the optical element 212.

In some embodiments, conformal retarder 120 may be unpatterned, or in some embodiments it may be patterned, as shown in FIG. 1. Conformal retarder 120 may include at least first regions 122 and second regions 124, arranged in any spatial pattern, gradient, or any other arrangement. First regions 122 and second regions 124 differ at least by their retardation of incident light. For example, in one embodiment, first regions 122 may have retardance of a quarter wave for incident light of a first wavelength. At the same time, second regions 124 may have substantially zero retardance for incident light of that first wavelength. In some embodiments, second regions 124 may substantially absorb light at that first wavelength. In some embodiments, second regions 124 may substantially depolarize light at the first wavelength. In some embodiment, the conformal retarder 120 may be unpatterned, but may be placed in discrete portions on a light directing article.

The light directing article maybe be itself, regardless of the location of the conformal retarder, spatially variant. For example, portions of the optical elements maybe intentionally nonfunctional to partially or completely block light in a regions. A spatially variant light directing article, along with the conformal retarder, would create optical patterns and optical signatures.

When the light directing article includes varying regions of conformal retarders, including regions without retarders, as described above, those retarder regions can be arranged relative to one another to form an optical pattern. An optical pattern can create an optical signature, which is a wavelength or polarization characteristic of the light sent from the light directing article to a detector. A spatially variant article, can have wavelength and polarization characteristics that vary across the area of the article. If the size of the regions is large enough to be individually resolved at a given observation distance these areas and their respective wavelength and polarization states can be individually detected. If the size of the regions is too small to be individually resolved at a given observation distance, the detector detects the combined signature of the different regions as composite optical signature. Such optical patterns and signatures maybe useful for creating a code. The information may be human readable, machine readable, or both human and machine readable. FIG. 10 shows and example of an embodiment of an optical pattern.

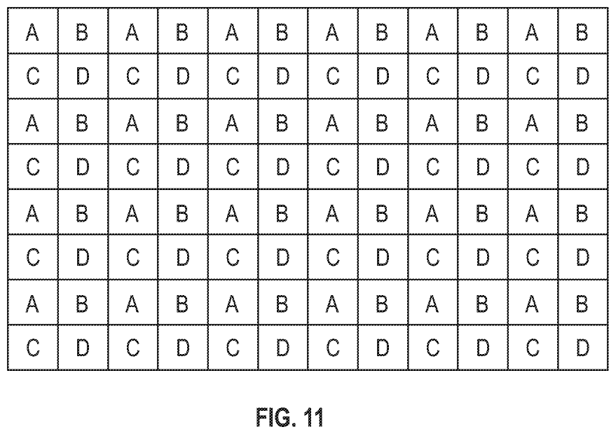

The light directing article may have polarization and/or wavelength properties that vary spatially in a repeating pattern. For example, FIG. 11 shows an example of a light directing article 100 with polarization and/or wavelength properties that vary spatially in a repeating pattern. In FIG. 11, each box A, B, C, and D indicates a particular polarization or wavelength property. It is understood, that the conformal retarder described herein, maybe included in some or all of A, B, C, or D.

To create optical patterns or optical signatures, a light directing article such as shown in FIG. 1 could be post-processed to modify selected regions of the pattern. For example, printing a light absorbing ink over all the “B” regions to partially or completely block light to this region would result in a particular optical pattern of the light directing article. Modifications could be accomplished with broadband or wavelength selective absorbers, scatterers, retarders, polarization modification.

In some embodiments, the conformal retarder on the light directing article might be uniformly applied such that the light directing article is spatially uniform. A spatially uniform article can have an optical signature, where the entire article has the same wavelength and polarization characteristics.

Retroreflecting article 100 may enable particular sensor systems to operate with a high degree of fidelity. For example, a sensor that detects circularly polarized light (for example, a charge coupled device or CMOS used in conjunction with a filter that passes left-handed circularly polarized light) may be a useful sensor configuration. Interrogated with left-handed circularly polarized light, for example, retroreflecting article 100 may provide certain portions (depending on the configuration and optics of retroreflecting layer 110 and conformal retarder 120) that retroreflect left-hand circularly polarized light. These may appear bright or be otherwise detectable with such a sensor configuration. In other portions of retroreflecting article 100, the left-hand circularly polarized interrogation light may be absorbed, or flipped to right-hand circularly polarized light. Such regions would appear dark or be difficult to detect with such a sensor configuration. Retroreflecting articles 100 may be used with a system described in U.S. Patent Application 62/578,151 (attorney docket number 80107US002), filed Oct. 27, 2017.

Wavelength selective absorbers or reflectors can be incorporated into any material in the optical path, including the conformal retarder. A wavelength selective absorber or reflectors maybe used to absorb or reflect, respectively, wavelengths in the visible, near-infrared, or mid-infrared light.

In some embodiments, by utilizing circularly polarized light, several potential advantages may be realized. In particular, circularly polarized light tends to be rare in nature, reducing the probability of a false positive signal or other interference.

Various configurations for a retroreflective material containing a non-depolarizing reflector are described in the following table. A polarized light source could emit different polarization states such as horizontal linearly polarized light (denoted as Linear H), vertical linear polarized light (denoted as Linear V), left circularly polarized light (Left CP), or right circularly polarized light (Right CP) as indicated on the left hand side of the table. The retroreflector can be designed to return different polarization states to a transceiver which include Linear H, Linear V, Left CP, and Right CP. The state of light that is returned to the transceiver depends on the properties of the conformal retarder as indicated in the cells of the table. For example, if Linear H light is incident on a retroreflector having a ¼ wave retarder, the retroreflector will rotate the polarization of the light 90 degrees and return Linear V. Another example is if Left CP light is incident on a retroreflector having ¼ wave retarder, the retroreflector will return Left CP light. Another example is if Linear H light is incident on a retroreflector having an ⅛ wave retarder, the retroreflector will return Left CP light. Conversely to have incident Linear H light and have the retroreflector return Right CP light, the retarder should be ⅜ wave. The Table 1 below is for the case of the conformal retarder slow axis at 45 degrees from vertical.

TABLE 1

| | | Light Returned to Transceiver from Retroreflector | | | |
|---|---|---|---|---|---|
| | | Linear H | Linear V | Left CP | Right CP |
| Light | Linear | isotropic | 1/4 wave | 1/8 wave | 3/8 wave |
| Source | H | | | | |
| | Linear | 1/4 wave | isotropic | 3/8 wave | 1/8 wave |
| | V | | | | |
| | Left CP | 1/8 wave | 3/8th wave | 1/4 wave | isotropic |

If the conformal retarder slow axis is −45 degrees from vertical, some of the retarder requirements change as indicated in Table 2 below.

TABLE 2

| | | Light Returned to Transceiver from | | | |
|---|---|---|---|---|---|
| | | Retroreflector | | | |
| | | Linear H | Linear V | Left CP | Right CP |
| Light | Linear | isotropic | 1/4 wave | 3/8 wave | 1/8 wave |
| Source | H | | | | |
| | Linear | 1/4 wave | isotropic | 1/8 wave | 3/8 wave |
| | V | | | | |
| | Left CP | 3/8 wave | 1/8 wave | 1/4 wave | isotropic |

Though not intended to be limiting, this shows that retardation levels of ⅛, ¼, and ⅜ are useful if the objective is to utilize circularly polarized light in the emission from the transceiver and/or the return of light from the retroreflector to the transceiver.

In some embodiments, retroreflecting article 100 may be configured to operate in the near-infrared wavelength range. Certain sensor systems utilize near-infrared light in order to operate within wavelengths that are invisible to humans. In some embodiments, retroreflecting article 100 may include a retroreflecting layer 110 that retroreflects near-infrared light, and a retardation layer 120 that is configured as a quarter wave retarder for at least one wavelength in the near-infrared wavelength range.

FIG. 10 is a retroreflecting article including the arbitrarily-aligned film illuminated with circular polarized light and viewed through a circular polarizing filter with retroreflecting article 100 and arbitrarily-aligned conformal retarder 120. It is understood that each of the retroreflecting articles described in FIGS. 1-8 can provide similar functionality as is shown in FIG. 10.

In one portion, because the handedness of the incident light is preserved, and because the light pass handedness of the polarizing filter is the same as the incident light, the retroreflecting article appears bright. Naturally, other combinations of components such as the incident light polarization, retroreflector type (for example, handedness-preserving or handedness-reversing), and pass-handedness of the circular polarizing filter apparent to the skilled person may be utilized to result in the retroreflecting article's bright appearance.

In another portion, because the handedness of the incident light is preserved, and because the light pass handedness of the polarizing filter is the opposite of the incident light, the retroreflecting article appears dark. Similarly, other combinations of components such as the incident light polarization, retroreflector type, and light pass handedness of the circular polarizer may be selected to provide a similarly dark appearance.

Another advantage of utilizing circularly polarized light and a retroreflective material containing a quarter wave retarder is that the visibility of the retroreflective light is largely invariant as a function of polar and azimuthal alignment between the polarizer that creates or detects the circular polarized light and the quarter wave retarder. In other words, such a retarder may be rotationally invariant with respect to the polarizer that creates or detects the circular polarized light. In some embodiments, this means that the retroreflecting layer has a retroreflective efficiency of not less than 70% of a maximum value as the retarder is rotating about the azimuth. For purposes of illustration, retroreflecting article 100 is assumed to be illuminated and detected under conditions that allow the pattern on the arbitrarily-aligned film to be visible (i.e., in certain embodiments the pattern would be invisible if not illuminated with circularly polarized light or even at all to human eyes). Applications related to this advantage include permanently or temporarily attachable stickers or decals that can be placed on signs, clothing, vehicles, horizontal surfaces, vertical surfaces, infrastructure, buildings, or the like. Because the quarter wave retarder does not need to be carefully aligned with the polarizer on either a light source or a detector, such decals may be easily attached without worry of misorientation or misalignment causing faulty or incomplete detection. Such decals or stickers may be temporarily attached to provide new machine-readable meanings to signs, clothing, or any other attachable surface.

FIGS. 2-8 show various embodiments of a light directing article with a conformal retarder. For embodiments that are retroreflecting articles, an optional phase reversing optical reflector is included. In each embodiment, only a single location of the conformal retarder is shown relative to the optical element. It is understood that more than one conformal retarder may be included on a single optical element. For example, in an embodiment with a bead, there may be a conformal retarder on both sides of the bead. For example, in an embodiment with a prism/microstructure, there may be a conformal retarder on one or more surfaces of the prism. For example, a first layer of a conformal retarder may be applied to an optical element, and a further layer of the same or different conformal retarder may be applied adjacent to the first layer of the conformal retarder.

FIG. 2 is cross sectional side view of an embodiment of a retroreflecting article 200 comprising a beadbond layer 210 and a conformal retarder 220. In this embodiment, the retroreflecting article 200 comprises a plurality of optical element 212 that are beads, a phase reversing optical reflector 214 that is a metal layer, and a conformal retarder 220. In this embodiment, the conformal retarder 220 is a substantially continuous layer that contours with the surface of beads at a first region 222. A second region 224 of beads does not have the conformal retarder 220. In this embodiment, the conformal retarder 220 is on a surface of the bead opposite from the phase reversing optical reflector 214. It is understood that although the conformal retarder 220 is shown applied to only a first region 222 of the beads, the conformal retarder 220 may be applied over an entire beadbond layer 210. It is understood that the conformal retarder 220 may be uniform or patterned as described above. In this embodiment, the conformal retarder 220 may be applied as a coating or as a film over the retroreflecting layer 210.

FIG. 3 is cross sectional side view of another embodiment of retroreflecting article 300 comprising a beadbond layer 310 and a conformal retarder 320. In this embodiment, the retroreflecting article 300 comprises a plurality of optical element 312 that are beads, a phase reversing optical reflector 314 that is a metal layer, and a conformal retarder 320. In this embodiment, the conformal retarder 320 is a substantially continuous layer that contours with the surface of beads at a first region 322. A second region 324 of beads does not have the conformal retarder 320. In this embodiment, the conformal retarder 320 is positioned between the optical element 312 and the phase reversing optical reflector 314. It is understood that although the conformal retarder 320 is shown applied to only a first region 322 of the beads, the conformal retarder 320 may be applied over an entire beadbond layer 310. It is understood that the conformal retarder 320 may be uniform or patterned as described above.

In this embodiment, the conformal retarder 320 maybe be applied as a coating or a film to a layer of optical elements 312 before application of the phase reversing optical reflector 314. For example, the optical elements 312 may be temporarily secured to a substrate, then the conformal retarder 320 is applied to the exposed optical element 312 followed by application of the phase reversing optical reflector 314. The temporary substrate is then removed to form a construction as shown in FIG. 3.

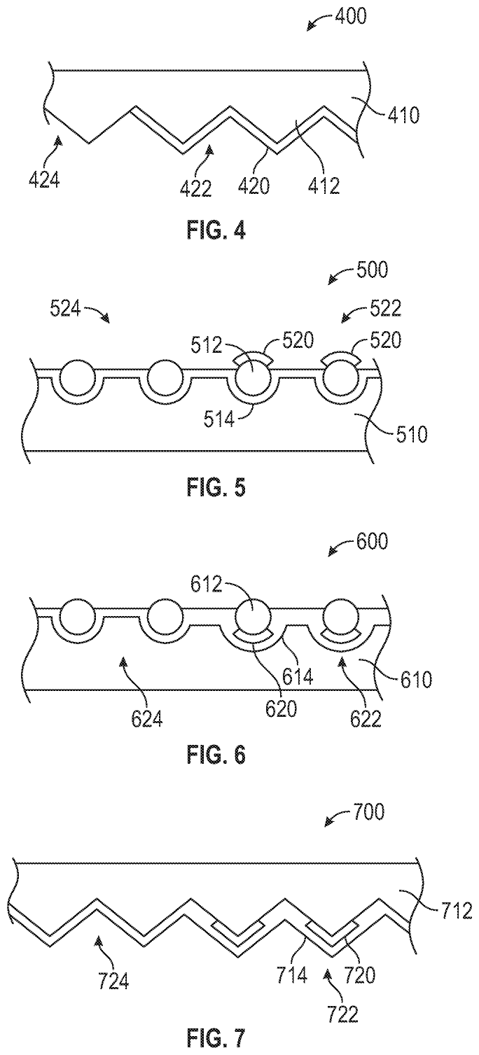

FIG. 4 is cross sectional side view of another embodiment of a light directing article 400 comprising a prism layer 410 and a conformal retarder 420. In this embodiment, the light article 400 comprises a plurality of optical element 412 that are prisms and a conformal retarder 420. It is understood that this embodiment may be a retroreflector if a phase reversing optical reflector is included adjacent to the prisms. In this embodiment, the conformal retarder 420 is a substantially continuous layer that contours with the surface of the optical elements at a first region 422. A second region 424 of the prisms does not have the conformal retarder 420. It is understood that although the conformal retarder 420 is shown applied to only a first region 422 of the prisms, the conformal retarder 420 may be applied over the entire light directing article 400. It is understood that the conformal retarder 420 may be uniform or patterned as described above.

In this embodiment, the conformal retarder 420 may be applied as a coating or a film over the prisms. Then, if forming a retroreflective article, following application of the conformal retarder 420, a reversing optical reflector can be applied over the conformal retarder 420.

It is understood that the phase reversing optical reflector in the other retroreflective articles described herein is optional and may be omitted if forming a light directing article and not a retroreflective article.

FIG. 5 is cross sectional side view of an embodiment of a retroreflecting article 500 comprising a retroreflecting layer 510 and a conformal retarder 520. In this embodiment, the retroreflecting article 500 comprises a plurality of optical element 512 that are beads, a phase reversing optical reflector 514 that is a metal layer, and a conformal retarder 520. In this embodiment, the conformal retarder 520 is a discontinuous layer that contours with the surface of the beads at a first region 522, wherein there are gaps in the conformal retarder 520 from one bead to the next within the first region 522. At a second region 524 of the beads there is no conformal retarder. In this embodiment, the conformal retarder 520 is on a surface of the bead opposite from the phase reversing optical reflector 514. It is understood that although the conformal retarder 520 is shown applied to only a first region 522 of the beads, the conformal retarder 520 may be applied over the entire light directing article 500. It is understood that the conformal retarder 520 may be uniform or patterned as described above.

FIG. 6 is cross sectional side view of an embodiment of a retroreflecting article 600 comprising a retroreflecting layer 610 and a conformal retarder 620. In this embodiment, the retroreflecting article 600 comprises a plurality of optical element 612 that are beads, a phase reversing optical reflector 614 that is a metal layer, and a conformal retarder 620. In this embodiment, the conformal retarder 620 is a discontinuous layer that contours with the surface of the beads at a first region 622, wherein there are gaps in the conformal retarder 620 from one bead to the next within the first region 622. At a second region 624 of the beads there is no conformal retarder. In this embodiment, the conformal retarder 620 is positioned between the optical element 612 and the phase reversing optical reflector 614. It is understood that although the conformal retarder 620 is shown applied to only a first region 622 of the beads, the conformal retarder 620 may be applied over the entire light directing article 600. It is understood that the conformal retarder 620 may be uniform or patterned as described above.

FIG. 7 is cross sectional side view of an embodiment of a retroreflecting article 700 comprising a retroreflecting layer 710 and a conformal retarder 720. In this embodiment, the retroreflecting article 700 comprises a plurality of optical element 712 that are cube-corners, a phase reversing optical reflector 714 that is a metal layer, and a conformal retarder 720. In this embodiment, the conformal retarder 720 is a discontinuous layer that contours with the surface of the cube-corners at a first region 722, wherein there are gaps in the conformal retarder 720 from one cube-corner to the next within the first region 722. In this embodiment, the conformal retarder 720 is on at least two of the surfaces of the cube-corner. At a second region 724 of the cube-corners there is no conformal retarder. In this embodiment, the conformal retarder 720 is positioned between the optical element 712 and the phase reversing optical reflector 714. It is understood that although the conformal retarder 720 is shown applied to only a first region 722 of the cube-corners, the conformal retarder 720 may be applied over the entire light directing article 700. It is understood that the conformal retarder 720 may be uniform or patterned as described above.

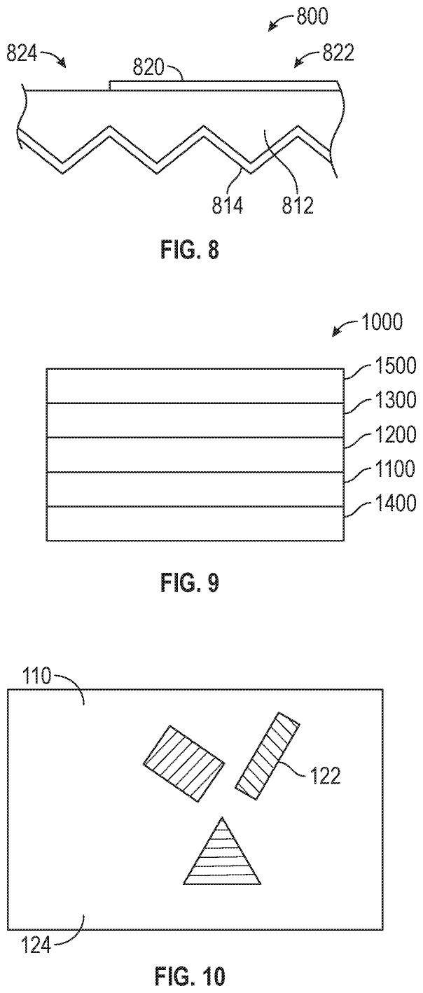

FIG. 8 is a cross sectional view of an embodiment of a retroreflecting article 800 comprising a retroreflecting layer 810 and a conformal retarder 820. In this embodiment, the retroreflecting article 800 comprises a plurality of optical element 812 that are cube-corners, a phase reversing optical reflector 814 that is a metal layer, and a conformal retarder 820. In this embodiment, the conformal retarder 820 is a continuous layer that is in direct contact to a base surface of the cube-corners at a first region 822. At a second region 824 of the cube-corners there is no conformal retarder. In this embodiment, the conformal retarder 820 is positioned at the base of the optical element 812 opposite from the phase reversing optical reflector 814. It is understood that although the conformal retarder 820 is shown applied to only a first region 822 of the cube-corners, the conformal retarder 820 may be applied over the entire light directing article 800. It is understood that the conformal retarder 820 may be uniform or patterned as described above.

FIG. 9 is a cross sectional view of an embodiment of a transfer article 1000 which may be used to apply a conformal retarder to an optical element. Similar transfer articles 1000 are described in U.S. Patent Application 62/478,992 filed Mar. 30, 2017, the disclosures of which is herein incorporated by reference. An exemplary transfer article 1000 includes a release layer 1100, a first acrylate layer 1200 overlaying the release layer 1100, and a retardation layer 1300 overlaying the first acrylate layer 1200.

The release layer 1100 can include a metal layer or a doped semiconductor layer. In the embodiment shown in FIG. 9, the first acrylate layer 1200 is in direct contact with the release layer 1100 and the retardation layer 1300. In other embodiments, there can be additional layers between the first acrylate layer 1200 and the retardation layer 1300. Transfer article 1000 may also include an optional substrate 1400 underlaying the release layer 1100. In the embodiment shown in FIG. 9, the substrate 1400 is in direct contact with the release layer 1100. In other embodiments, there can be additional layers between the substrate 1400 and the release layer 1100. In some embodiments, the transfer article 1000 may further include a second acrylate layer 1500 overlaying the retardation layer 1300. In these embodiments, the retardation layer 1300 may be between the first acrylate layer 1200 and the second acrylate layer 1500. In some embodiments, the transfer article 1000 may further include an second layer 1500 comprising oxide or an adhesive overlaying the retardation layer 1300. In these embodiments, the retardation layer 1300 may be between the acrylate layer 1200 and the second layer 1500.

In some embodiments, a release value between the release layer 1100 and the first acrylate layer 1200 is less than 50 grams per inch (g/inch), 40 g/inch, 30 g/inch, 20 g/inch, 15 g/inch, 10 g/inch, 9 g/inch, 8 g/inch, 7 g/inch, 6 g/inch, 5 g/inch, 4 g/inch or 3 g/inch. In some embodiments, a release value between the release layer 1100 and the first acrylate layer 1200 is more than 1 g/inch, 2 g/inch, 3 g/inch or 4 g/inch. In some embodiments, a release value between the release layer 1100 and the first acrylate layer 1200 is from 1 to 50 g/inch, from 1 to 40 g/inch, from 1 to 30 g/inch, from 1 to 20 g/inch, from 1 to 15 g/inch, from 1 to 10 g/inch, from 1 to 8 g/inch from 2 to 50 g/inch, from 2 to 40 g/inch, from 2 to 30 g/inch, from 2 to 20 g/inch, from 2 to 15 g/inch, from 2 to 10 g/inch, or from 2 to 8 g/inch. Release value means with reference to average peel force determined by the test for T-Peel test according to ASTM D1876-08 “Standard Test Method for Peel Resistance of Adhesives (T-Peel Test)”.

The transfer article 1000 can be used to transfer the first acrylate layer 1200 and the retardation layer 1300, so that the release layer 1100 and/or the substrate 1400 can be reused. The transfer article 1000 can be applied to a surface of interest, for example, an optical element, with the retardation layer 1300 being between the first acrylate layer 1200 and the surface of interest. After the transfer article 1000 is applied to the surface of interest, the release layer 1100 and the substrate 1400, if present, can be removed from the transfer article 1000. The first acrylate layer 1200 and the retardation layer 1300 are left on the surface of interest. In some embodiments, the optional second layer 1500 can help the retardation layer 1300 to attach to the surface of interest.

A transfer article 1000 may be used to provide the substantially uniform thickness, discontinuous conformal retardation layer to optical elements such as shown in the embodiments of FIGS. 5, 6, and 7.

Light directing article as described herein may further comprise a protecting layer at an outermost surface of the light directing article. A protective layer can protect the underlying optical elements, conformal retarder, and optional phase reversing optical reflector.

Light directing articles as described herein may be useful for traffic control signs and directional/navigational infrastructure. In some embodiments, retroreflecting articles as described herein may be useful as rigid signs. In some embodiments, these articles may be or included in temporary traffic control devices, such as cones or flags or portable signs. In some embodiments, these articles may be used or incorporated into clothing or wearable items, such as conspicuity vests, helmets, or other safety equipment. In some embodiments, the retroreflecting articles may be conformable, washable, breathable, bendable, rollable, or foldable. In some embodiments, a light directing article is a window film. In some embodiments, these articles may be attached to any type of vehicle, such as a car, motorcycle, airplane, bicycle, quadcopter (drone), boat, or any other vehicle. In some embodiments, these articles can be used for material handling and inventory control in a warehouse, train yard, shipyard, or distribution center, allowing, for example, for the automated identification of the content of shelves, boxes, shipping containers, or the like. They can be used for augmented reality (AR) where the AR system can detect the film for wayfinding or to read a code.

Retroreflecting articles as described herein may be any suitable size, from small decals or stickers including pressure sensitive adhesive to large, highly visible traffic signs. Substrates to provide rigidity or easy adhesion (for example, pressure sensitive adhesion) may be also included behind the retroreflecting layer without affecting the optics of the retroreflecting article.

In one aspect, the articles of the present application may be used to uniquely identify light directing articles with an optical sensor system modulating polarization states of circular polarizers on light source and/or camera, such as described in U.S. patent application 62/578,151 filed on Oct. 27, 2017. For example, a light directing article according to the present application would appear bright in the presence of a system having setup 2 and dark in a system having setup 3. In comparison, a light directing article with a phase-reversing reflector, but without retarder, would appear dark in the presence of a system having setup 2 and bright in a system having setup 3, while a light directing article with a depolarizing reflector would appear bright in the presence of both systems. By having different appearances in setups 2 and 3, a light directing article according to the present application could be uniquely identified and detected when in the presence of light directing articles that did not include conformal retarders (e.g., retroreflective articles commonly found on roads such as, for example, existing traffic signs or license plates).

In one aspect, the presently described articles may be used to create optical signatures that are detectable by modulating different polarization states in the visible spectrum. As such, visible cameras which are already mounted on most autonomous vehicles may be used in identifying such optical signatures. In one embodiment, the optical signature is created by patterning the conformal retarder so that it forms a barcode. In another embodiment, the optical signature is created by patterning the conformal retarder so that it forms indicia recognizable and understood by a human or machine. In other aspect, the presently described articles may be used to create optical signatures that are detectable by modulating different polarization states in the near-IR spectrum.

In one aspect, the present application relates to a system for identifying a light directing article. In one embodiment, the system setup includes a light source with a circular polarizer disposed on the optical path of the light source (i.e., light passes through the circular polarizer), a light directing article including a conformal retarder disposed on optical elements of the light directing article, and a receiving unit capable of receiving light directed to it by the light directing article. In some embodiments, the receiving unit is a camera. In some embodiments, a circular polarizer is disposed on the receiving unit in a direction parallel to the circular polarizer for the light source. In other embodiments, a circular polarizer is disposed on the receiving unit in a direction orthogonal to the circular polarizer for the light source.

In some embodiments, at least two receiving units are part of the system. In one embodiment, a first receiving unit includes a first circular polarizer disposed thereon, so that the first circular polarizer is in a direction that is parallel to the light source. A second receiving unit includes a second circular polarizer disposed thereon, so that the second circular polarizer is in a direction orthogonal to the light source.

In some embodiments, the system further includes a processor for processing information obtained by the receiving unit. In one embodiment, the first receiving unit generates a first output obtained under a first set of conditions. The second receiving unit generates a second output, obtained under a second set of conditions, different from the first set of conditions. In some embodiments, the processor compares the first and second output and provides a response or command.

In some embodiments, the first and second receiving units are cameras, the first and second outputs are images, and the first and second conditions are different polarization states. In some embodiments, the cameras operate in visible wavelengths (e.g., 400-700 nm). In other embodiments, the cameras operate in near infrared wavelengths (e.g., 700-1400 nm).

In some embodiments, a light directing article including a patterned conformal retarder is provided as a sign on a roadway. The patterned conformal retarder forms an optical signature that is only detected by modulating polarization states.

In some embodiments, an autonomous vehicle includes a light source having a circular polarizer disposed thereon and at least one receiving unit having a first and second circular polarizers disposed thereon so that the first circular polarizer is in a direction parallel to the circular polarizer in the light source and the second circular polarizer is in a direction orthogonal to the circular polarizer in the light source. The autonomous vehicle further includes a processor capable of analyzing outputs from the receiving unit. The processor subsequently generates a response based on the analysis performed on the outputs of the receiving unit.

In some embodiments, the at least one receiving unit produces a first output and a second output, wherein the first and second outputs are generated under different conditions. In one embodiment, the first output is an image taken under a first polarization state and the second image is an image taken under a second polarization state, wherein the first polarization state is different from the second polarization state.

In one embodiment, the processor compares the first and second images and produces a response. In some embodiments, the response is a command to an autonomous vehicle. Exemplary commands include reducing vehicle speed, changing vehicle direction, changing level of autonomy, and modifying driving pattern.

In one embodiment, the processor compares first and second images and determines based on differences between the images that a detected article includes a light directing article according to the present application. In some embodiments, the light directing article includes an optical signature that conveys information to the autonomous vehicle. The processor detects the optical signature, interprets the conveyed information and generates a command to the vehicle in response to the information provided.

An exemplary method for detecting light directing articles according to the present application includes: providing a light directing article having optical elements and a conformal retarder that contours at least some of the optical elements, illuminating the light directing article using a light source that includes a circular polarizer disposed on the optical path of the light, and providing a first receiving unit and a second receiving unit, wherein the first receiving unit includes a first circular polarizer disposed on it in a direction that is parallel to the circular polarizer in the light source, and wherein the second receiving unit includes a second circular polarizer disposed on it in a direction that is orthogonal to the circular polarizer in the light source.

### Additional Embodiments

1. A light directing article comprising:
an optical element;
a conformal retarder of a predefined thickness that contours the optical element.
   2. The light directing article of embodiment 1, wherein the optical element comprises a bead, prism, or microstructure comprising a cube corner.
   3. The light directing article of any one of the preceding embodiments, further comprising a phase reversing optical reflector;
   4. The light directing article of any one of the preceding embodiments, wherein the phase reversing optical reflector comprises a metalized layer or a dielectric stack.
   5. The light directing article of any one of the preceding embodiments, wherein the light directing article is a retroreflective article.
   6. The light directing article of any one of the preceding embodiments, wherein the conformal retarder has a substantially uniform thickness.
   7. The light directing article of any one of the preceding embodiments, wherein the conformal retarder is in direct contact with the optical element.
   8. The light directing article of any one of the preceding embodiments, wherein the conformal retarder contacts only a portion of the optical element.
   9. The light directing article of any one of the preceding embodiments, wherein the conformal retarder contacts more than 5% and less than 100% of the optical element.
   10. The light directing article of any one of the preceding embodiments, wherein the conformal retarder is positioned between the optical element and the phase reversing optical reflector.
   11. The light directing article of any one of the preceding embodiments, wherein the phase reversing optical reflector is adjacent to the optical element and the conformal retarder is positioned on the surface of the optical element opposite from the phase reversing optical reflector.
   12. The light directing article of any one of the preceding embodiments, wherein the conformal retarder is patterned to include at least a first retarder region with a first retarder property and a second retarder region with a second retarder property, that is different from the first retarder property.
   13. The light directing article of any one of the preceding embodiments, wherein the first retarder region is a quarter wave retarder for at least one wavelength in the near infrared range and the second retarder region is a quarter wave retarder for at least a different wavelength, and has substantially zero retardance or absorbs the at least one wavelength in the near infrared range.
   14. The light directing article of any one of the preceding embodiments, wherein the first retarder region and the second retarder region are arranged to form an optical signature.
   15. The light directing article of any one of the preceding embodiments, wherein the optical signature has a specific wavelength or polarization state.
   16. The light directing article of anyone of the preceding embodiments, further comprising a plurality of optical elements forming a first region of optical elements with the conformal retarder and a second region of optical elements without the conformal retarder.
   17. The light directing article of any one of the preceding embodiments, light directing article the first region and second region are arranged to form an optical signature.
   18. The light directing article of anyone of the preceding embodiments, wherein the conformal retarder substantially continuously contours with the optical elements at the first region of optical elements.
   19. The light directing article of anyone of the preceding embodiments, wherein the conformal retarder discontinuously contours with each of the optical elements at the first region of optical elements.
   20. The light directing article of any one of the preceding embodiment, wherein the conformal retarder is patterned to form a code, detectable by modulating different polarization states.
   21. The light directing article of any one of the preceding embodiments, further comprises a protecting layer at an outermost surface of the light directing article and wherein the conformal retarder is positioned between the protective layer and the phase reversing optical reflector.
   22. The light directing article of any one of the preceding embodiments, further comprises a protecting layer at an outermost surface of the light directing article and wherein the conformal retarder is positioned between the protective layer and the optical element.
   23. The light directing article of any one of the preceding embodiments, wherein the conformal retarder is transparent under the visible light spectrum.
   24. A method of making a light directing article comprising:
applying a uniform thickness of a conformal retarder to an optical element.
   25. The method of embodiment 24, further comprising applying the conformal retarder continuously to a plurality of optical elements.
   26. The method of embodiment 24, further comprising applying the conformal retarder discontinuously to a plurality of optical elements.
   27. The method of any one of embodiments 24 to 26, further comprising applying a transfer article comprising the conformal retarder and a release layer to the optical element.

### EXAMPLES

Materials

| Trade Designation/ | | |
|---|---|---|
| Abbreviation/ | | |
| Trademark | Material | Supplier |
| VITEL 3550B | Co-polyester solution having a glass | Bostik Company, |
| | transition temperature of 16° C., melt flow | Wauwatosa, WI |
| | of 125° C., and intrinsic viscosity of 0.85 | |
| | dl/g | |
| VITEL V5833B | Co-polyester solution having a glass | Bostik Company |
| | transition temperature of 48° C., melt flow | |
| | of 99° C., and intrinsic viscosity of 0.17 | |
| | dl/g | |
| VITEL 3580 | Co-polyester solution | Bostik Company, |
| | | Wauwatosa, WI |
| SILQUEST A-1310 | Gamma-isocyanatopropyltriethoxysilane | Momentive Performance |
| | | Materials Inc., Albany, NY |
| DESMODUR L-75 | Liquid aromatic polyisocyanide polymer | Covelco, Pittsburgh, PA |
| | based on toluene diisocyanate | |
| GT-17 SATURN | A fluorescent lime-yellow pigment | Day Glo Color Corporation, |
| YELLOW | powder | Cleveland, Ohio |
| DABCO T-12 | Dibutyltin dilaurate-based liquid catalyst | Evonik GmbH, Essen, |
| | | Germany |
| MEK | Methyl ethyl ketone | VWR International, |
| | | Radnor, PA |
| TOLUENE | Toluene, solvent | VWR International, |
| | | Radnor, PA |
| MIBK | Methyl isobutyl ketone, solvent | VWR International, |
| | | Radnor, PA |
| LPP | Liquid crystal alignment layer material, | Rolic Technologies Ltd. |
| | ROP-131 EXP 306 | Switzerland |
| LCP | Liquid crystal polymer layer material, | Rolic Technologies Ltd. |
| | ROF-5185 EXP 410 | Switzerland |
| SARTOMER | Liquid acrylate based on tricyclodecane | Sartomer USA, Exton, PA |
| SR833S | dimethanol diacrylate | |
| KRATON D1114 | Linear, triblock copolymer based on | Kraton Corporation, |
| | styrene and isoprene with a polystyrene | Houston, TX |
| | content of 19% | |
| AFFINITY 1850 | Polyolefin plastomer resin | The Dow Chemical |
| | | Company, Midland, MI |
| GLASS | Glass microspheres were prepared as | |
| MICROSPHERES | described in Example 1 of | |
| | U.S. Pat. No. 3,700,305, | |
| | the disclosure of which is incorporated | |
| | herein in its entirety. | |
| CARRIER SHEET | Polyethylene coated paper film | Felix Schoeller Group, |
| | | Osnabruck, Germany |
| EHA | 2-Ethylhexyl acrylate | BASF, Florham Park, NJ |
| IBOA | Isobornyl acrylate | San Esters, New York, NY |
| AA | Acrylic acid | BASF |
| HEA | 2-Hydroxyl ethyl acrylate | BASF |
| MOWITAL B60H | Poly(vinyl butyral) having a glass | Kuraray, Houston, TX. |
| | transition temperature (Tg) of 70° C. | |
| CN963 B80 | Blend of aliphatic polyester based | Sartomer |
| | urethane diacrylate oligomer blended | |
| IRGACURE 651 | 2,2-Dimethoxy-1,2-diphenylethan-1-one | BASF |
| IRGANOX 1035 | A sulfur-containing, primary (phenolic) | BASF |
| | antioxidant and heat stabilizer | |
| TINUVIN 479 | Hydroxyphenyl-triazine (HPT) UV | BASF |
| | absorber | |
| TINUVIN 928 | UV absorber of the hydroxyphenyl | BASF |
| | benzotriazole class | |
| DESMODUR XP | An NCO prepolymer based on | Bayer MaterialScience, |
| 2617 | hexamethylene diisocyanate | Pittsburgh, PA, |
| EBECRYL 3720 | bisphenol A epoxy diacrylate | Allnex, Alpharetta, GA |
| TMPTA | Trimethyloiproparie triacrylate | Sartomer USA, Exton, PA |
| HDDA | 1,6-Hexanediol diacrylate | Sartomer USA, Exton, PA |
| DAROCUR TPO | 2,4,6-Trimethylbenzoyl-diphenyl- | BASF, Florham Park, NJ |
| | phosphineoxide | |
| DAROCUR 1173 | 2-Hydroxy-2-methylpropiophenone | BASF, Florham Park, NJ |

Test Methods

Brightness:

Brightness of light directing articles was measured from photograph images, taken as 8-bit image file. The images were analyzed with an image analysis software (“IMAGE J” available from NIH (Bethesda, Md.)). Brightness shown in Table 5 was calculated as the average brightness measured at three different regions of the light directing articles. Brightness Retention (%) was calculated by dividing Brightness of the light directing article in the presence of the indicated circular polarizers by Brightness measured with no polarizer on light source/camera, adjusted by camera shutter speed and gain. Brightness is unitless while brightness retention is reported as a percentage.

Retroreflectivity (R_{A}):

light directing articles prepared or obtained as described below were evaluated for retroreflectivity performance by measuring the coefficient of retroreflectivity (R_{A} as described in U.S. Pat. No. 3,700,305) using a ROADVISTA 933 retroreflectometer (obtained from RoadVista, San Diego, Calif.), following the test criteria described in ASTM E810-03 (2013), “Standard Test Method for Coefficient of Retroreflective Sheeting using the Coplanar Geometry”. Retroreflectivity is reported in cd/lux/m². Unless otherwise stated, an observation angle of 0.2 degrees and an entrance angle of 5 degrees were used.

Color (x, y, Y):

Color luminance (Y), and chromaticity coordinates x and y were measured following the procedure described in ASTM E 308-90, Standard Practice for Computing the Colors of Objects by Using the CIE System”, using the following operating parameters: standard illuminant: D65 daylight illuminant; standard observer angle: 2°; wavelength interval: 400-700 nanometers at 10 nanometer intervals; incident light angle: 0° on sample plane; viewing angle: 45° through a ring of 16 fiber optic receptor stations; and port size: 0.5 inch (1.27 cm) diameter.

Preparations

Circular Polarizer (CP)

A circular polarizer was constructed by placing a linear polarizer film (SANRITZ HLC 2-5618, available from MicroVideo Systems) on top of a quarter-wave retarder film (Part number APQW92-003-PC, ¼ wave centered at 560 nm, American Polarizer, Inc.), so that pass axis of the linear polarizer was at +45 degree angle with fast axis of the retarder film.

When the circular polarizer was placed on top of light directing articles as presently described, the rotational angle was defined as the angle between the pass axis of the linear polarizer and the coating direction of the liquid crystal alignment layer (see below). Average retroreflectivity with the circular polarizer (R_{A} with CP) was calculated as an average of retroreflectivity (R_{A}) measured at three rotational angles (0, +45, +90 degree). Retroreflectivity Retention with the circular polarizer (% R_{A} retention with CP) was calculated by dividing (R_{A} with CP) by the retroreflectivity (R_{A}) of the light directing article with no circular polarizer on light source/camera.

Preparation of Mirror Transfer Film

A mirror transfer film was made on a roll to roll vacuum coater similar to the coater described in U.S. Patent Application No. 2010/0316852, the disclosure of which is incorporated herein in its entirety by reference, with the exception that: (i) the vacuum coater used in the present application included a second evaporator and curing system located between the plasma pretreatment station and the first sputtering system; and (ii) using evaporators as described in U.S. Pat. No. 8,658,248, the disclosure of which is incorporated herein by reference in its entirety.

The vacuum coater was further outfitted with a PET substrate in the form of a polyethylene terephthalate (PET) roll 1000 ft (304.8 m) long, 0.05 mm thick, and 14 inch (35.6 cm) wide. The substrate was prepared for coating by subjecting it to a nitrogen plasma treatment to improve the adhesion of the metallic layer. The film was treated with a nitrogen plasma operating at 120 W using a titanium cathode, using a web speed of 9.8 meters/min and maintaining the backside of the film in contact with a coating drum chilled to −10° C.

A release layer of SiAl was deposited on the PET substrate using a cathode had a Si(90%)/Al(10%) target obtained from Soleras Advanced Coatings US, of Biddeford, (ME). A conventional AC sputtering process employing Ar gas and operated at 24 kW of power was used to deposit a 37 nm thick layer of SiAl alloy onto the PET substrate to form a SiAl-coated PET substrate.

A 12.5 inches (31.8 cm) wide layer of SARTOMER SR833S acrylate was deposited on the SiAl side of the SiAl-coated PET substrate using ultrasonic atomization and flash evaporation. Once condensed onto the SiAl layer, the acrylate was cured immediately with an electron beam curing gun operating at 7.0 kV and 10.0 mA.

A second layer of SiAl was applied to the acrylate side of the PET substrate as described above, except that the second SiAl layer was 12 nm thick and deposited as an oxide.

A phase-reversing reflective aluminum layer was deposited on the second SiAl side of the PET substrate, using a pair of aluminum cathode targets obtained from ACI Alloys of San Jose, Calif. The aluminum reflector layer was 90 nm thick.

Preparation of Composite Elastomeric Article

A composite elastomeric article was prepared as described in U.S. Pat. Nos. 5,223,276 and 9,327,441, and PCT Publication No. WO99/36248 (their disclosures are incorporated herein by reference in their entireties).

A 3-layer feed block (ABA plug) in combination with a single layer manifold die (10-inch (254 cm) width) was used to generate 3-layer films with an elastomeric core (KRATON D1114) and polyolefin plastomer skins (AFFINITY 1850). The core material was melted at 400° F. (204° C.) in a single screw extruder and fed into one of the inlets of the 3-layer feed block, while the skin material was melted at 360° F.(182° C.) in a twin-screw extruder and fed into a second inlet in the feed block where it split into two streams to encapsulate the core layer on both sides. The composite elastomeric film was then cast directly from the die onto a chilled roll maintained at 60-70° F. (15-21° C.). The caliper and core-skin ratio was varied by adjusting the line speed of the winder unit and changing the configuration of the floating vanes in the feed block respectively. Multilayer films with thickness ranging from 2-5 mils (0.051-0.127 mm) and core-skin ratio ranging from 10-30 were produced and used for the transfer process.

Preparation of First Laminate

The e composite elastomeric film was laminated to the aluminum-side of the mirror transfer film at 230° F. (110° C.). The SiAl-coated PET substrate was then removed from the article producing first laminate comprising the elastomeric composite film and reflective aluminum layer.

Preparation of First Laminate with Conformal Retarder

A Conformal Retarder including a liquid crystal alignment layer and a liquid crystal polymer layer was applied to the reflective aluminum layer side of the first laminate.

The liquid crystal alignment layer was prepared by coating LPP on the reflective aluminum layer of the first laminate using a standard K bar number 0 in a K101 Control Coater (Testing Machines, Inc., Delaware). The liquid crystal alignment material was then dried at 131° F. (55° C.) for 2 minutes and cured with a mercury arc lamp (commercially available from Fusion Systems, Gardena, Calif.) through a wire grid polarizer (obtained as Part number UVT240A, from Moxtek, Inc, Utah). The wire grid polarizer was oriented such that the wire grid was at +45 degree from the coating direction of the liquid crystal alignment layer.

The liquid crystal polymer layer was prepared by coating LCP on the liquid crystal alignment layer using a standard K bar number 1 and the K101 Control Coater. The liquid crystal polymer layer was dried at 131° F. (55° C.) for 2 minutes, and subsequently cured with the mercury arc lamp in an inert environment.

Preparation of Acrylate Top Film

An acrylate top film composition was prepared as described in Base Syrup 2 of co-pending PCT Patent Application No. PCT/US2017/035882 (Attorney Docket No. 78496WO003), the disclosure of which is incorporated herein by reference in its entirety.

Components listed in Table 1, below, were mixed until a homogeneous composition was obtained. Amounts are expressed in parts by total weight of the composition (ppw).

TABLE 1

| Components | Amount (ppw) |
|---|---|
| EHA | 29.1 |
| MOWITAL B60H | 16.2 |
| IBOA | 8.1 |
| AA | 19.9 |
| HEA | 19.9 |
| CN963 B80 | 2.5 |
| DESMODUR XP 2617 | 2.5 |
| IRGACURE 651 | 0.3 |
| IRGANOX 1035 | 0.2 |
| TINUVIN 928 | 0.74 |
| TINUVIN 479 | 0.37 |

Base Syrup 2 was coated using a notch bar coater at a thickness of 0.002 inches (51 micrometers) between two PET liners, each having a nominal thickness of 51 micrometers obtained from Dupont Teijin, Dupont Chemical Company, Wilmington Del. The coated sheet was exposed to a total UV-A energy of 1824 milliJoules/square centimeter using a plurality of fluorescent lamps having a peak emission wavelength of 350 nanometers, to give a non-pressure sensitive adhesive (PSA) acrylate film between the PET liners.

Preparation of Acrylate Top Film with Conformal Retarder

A Conformal Retarder including a liquid crystal alignment layer and a liquid crystal polymer layer prepared as described above was disposed on the acrylate film after removal of one of the PET liners, similarly to the procedure described in Preparation of First Laminate with Conformal Retarder, above.

### EXAMPLES

### Comparative Example A

A beaded metallized (i.e., phase reversing reflector) light directing article was obtained under the trade designation “3M SCOTCHLITE C750” from 3M Company, St. Paul, Minn., and is hereinafter referred to as Comparative Example A.

### Comparative Example B

A prismatic metallized (i.e., phase reversing reflector) light directing article was obtained under the trade designation “3M retroreflective sheeting commercially available from 3M Brazil (of Sumare, Brazil) under the trade designation “Pelicula Refletiva 3M para placa de veiculo”, and is hereinafter referred to as Comparative Example B.

### Comparative Example C

A prismatic sealed (i.e., depolarizing reflector) light directing article was obtained under the trade designation “DIAMOND GRADE DG³ REFLECTIVE SHEETING SERIES 4090 WHITE” from 3M Company and is hereinafter referred to as Comparative Example C.

### Example 1

A beaded light directing article according to the present application was prepared as described below.

Glass microspheres were partially and temporarily embedded in a carrier comprising paper juxtaposed against a polyethylene layer that was about 25 to 50 micrometers thick. The carrier was placed in a convection oven to 220° F. (104° C.). The glass microspheres were then dropped onto the polyethylene side of the carrier and the carrier was left in the convection oven for 60 seconds. The microsphere-containing carrier was removed from the oven and allowed to cool to room temperature. Excess beads were removed, and the microsphere-containing carrier was placed in an oven at 320° F. (160° C.) for 60 seconds and subsequently removed from the oven and allowed to cool to room temperature. The microspheres were partially embedded in the polyethylene layer of the microsphere-containing carrier such that more than 50 percent of the microspheres was exposed.

A polymer solution was prepared by mixing 7 68 parts of VITEL 3550B, 0.32 parts of SILQUEST A-1310, 1.24 parts of DESMODUR L-75, 86.9 parts of MEK and 3.85 parts of Toluene, at 2400 rpm for 60 seconds using a DAC 150.1 FVZ-K Speedmixer (FlackTek Inc, Landrum, S.C.). The solution was coated onto the microsphere side of the microsphere-containing carrier using a notch bar coater gapped at 50 micrometers, then dried for 3 minutes at 150° F. (65.5° C.) followed by an additional 4 minutes at 200° F. (93.3° C.).

The polymer coating was then corona treated and laminated to the liquid crystal polymer layer of the First Laminate with Conformal Retarder prepared as described above. Lamination occurred at a temperature of 77° F. (25° C.) and laminating speed of 1 foot per minute (0.3 meters per minute). The composite elastomeric article was then removed from the construction, thereby exposing the reflective aluminum layer.

An adhesive composition was prepared according to procedures described in US2017/0192142, the disclosure of which is incorporated herein by reference in its entirety, by mixing the following components: 60.6 parts of VITEL 3550B, 10.9 parts of VITEL V5833B, 6.9 parts of GT-17 SATURN YELLOW, 2.4 parts of DESMODUR L-75, 1.2 part of SILQUEST A-1310, 1.2 part of 10% DABCO T-12 in MEK, 10.9 parts of MEK, and 6.9 parts of MIBK. The adhesive composition was added into a MAX 40 Speedmixer cup, and mixed at 2400 rpm for 60 seconds, and subsequently coated onto reflective aluminum layer using a laboratory notch bar coater with a 0.008 inch (0.2 mm) gap. The coated sample was dried for 30 seconds at 160° F. (71.1° C.), followed by additional 3 minutes at 180° F. (82.2° C.). The coated sample was then laminated onto a polyamide fabric using a roll laminator at 220° F. (104.4° C.) at a roller speed of approximately 32 inches per minute (813 mm/min). Light directing article of Example 1 was prepared by removing the carrier sheet from the multi-layer construction.

Retroreflectivity (R_{A}) and color for Comparative Example A and Example 1 were measured using the procedures described above. Circular Polarizer (CP), prepared as described above, was placed on the article of Example 1 and Comparative Example A. Individual R_{A} with CP at three rotational angles (0°, +45°, +90°), average R_{A} with CP, and % R_{A} retention with CP were calculated as described above. Results are reported in Table 2, below.

TABLE 2

| | Comparative | Example |
|---|---|---|
| | Example A | 1 |
| R_{A} | 520 | 311 |
| R_{A} with CP (0°) | 4 | 51 |
| R_{A} with CP (+45°) | 4 | 58 |
| R_{A} with CP (+90°) | 5 | 55 |
| Average R_{A} with CP | 4 | 54 |
| % R_{A} Retention with CP | 0.8% | 17.4% |
| Y | 26.7 | 43.3 |
| x | 0.3032 | 0.3451 |
| y | 0.3204 | 0.4562 |

### Example 2

A prismatic light directing article of Example 2 was prepared as it follows.

A plurality of optically active elements, specifically, microreplicated cube corner structures were provided on the conformal retarder side of the Acrylate Top Film with Conformal Retarder. The cube corner structure (prior to separating the structure into individual cubes) had 3 sets of intersecting grooves as having a pitch (i.e., primary groove spacing) of 0.004 in (0.01 cm) with base triangle apertures of 58/58/64 degrees resulting in the height of the cube corner elements being 50.0 microns (2 mils).

The cube corner structures were formed using a resin prepared by combining 25 wt-% EBECRYL 3720, 50 wt-% TMPTA and 25 wt-% HDDA. The resin also included 0.5 pph of TPO and 0.5 pph of DAROCUR 1173. A 170 nm thick phase reversing optical reflector aluminum layer subsequently was vacuum coated on the cube corner structures.

Retroreflectivity (R_{A}) for Comparative Examples B and C, and Example 2 was measured using the procedures described above. Circular Polarizer (CP), prepared as described above, was placed on the article of Example 2, Comparative Examples B and C. Individual R_{A} with CP at three rotational angles (0°, +45°, +90°), average R_{A} with CP, and % R_{A} retention with CP were calculated as described above.

Results are reported in Table 3, below.

TABLE 3

| | Comparative | Comparative | Example |
|---|---|---|---|
| | Example B | Example C | 2 |
| R_{A} | 851 | 1000 | 594 |
| R_{A} with CP (0°) | 8 | 58 | 154 |
| R_{A} with CP (+45°) | 7 | 72 | 153 |
| R_{A} with CP (+90°) | 8 | 77 | 145 |
| Average R_{A} with CP | 8 | 69 | 151 |
| % R_{A} Retention with CP | 0.9% | 6.9% | 25.4% |

As shown in Table 3, light directing articles including a conformal retarder and a phase-reversing optical reflective layer (Example 2) had higher retroreflectivity retention than light directing articles having a phase reversing optical reflective layer but without the conformal retarder (Comparative Example B). Similarly, light directing articles of the present application (Example 2) had higher retroreflectivity retention when compared to air-sealed light directing articles with a depolarizing reflector (Comparative Example C).

Long-range visibility of light directing articles was tested by photography in the dark, with a distance of 10 meters between the samples and camera/light. Visible retroreflective photographs of samples were taken with an observation angle of 1.8° and an entrance angle of approximately 10°. The visible camera was a FLIR CHAMELEON3 CM3-U3-50S5C-CS with a 16 mm focal length Tamron C Mount Lens (Part number 16FM16S, Tamron USA). Camera aperture setting of f/5.6 was used for all image capture. Visible light source was a NILIGHT white LED light (part number NI23E-51, Znder, Inc)

Circular Polarizers (CP) were placed in front of the camera and/or in front of the light source, as shown in Table 4, below. In the testing with the circular polarizer placed on the camera in a direction parallel to the circular polarizer placed on the light source (parallel), both circular polarizers had the pass axis of the linear polarizer at +45 degree angle with the fast axis of the retarder film. In the testing with orthogonal circular polarizers, one circular polarizer had pass axis of the linear polarizer at +45 degree angle with the fast axis of the retarder film, while the other circular polarizer had the pass axis of the linear polarizer at −45 degree angle with the fast axis of the retarder film.

System setup and parameters are shown in Table 4, below.

Brightness and Brightness Retention (%) were calculated following the procedure described above. Results are shown in Table 5, below.

TABLE 4

| | CP on | CP on | Camera | Shutter |
|---|---|---|---|---|
| Setup | light source | camera | gain | speed (ms) |
| Setup 1 | no | no | 8 | 2 |
| Setup 2 | Yes | parallel | 12 | 4 |
| Setup 3 | Yes | orthogonal | 12 | 4 |

TABLE 5

| | Brightness | | | Brightness Retention (%) | | |
|---|---|---|---|---|---|---|
| | Com- | Com- | Ex- | Com- | Com- | Ex- |
| | parative | parative | ample | parative | parative | ample |
| Setup | Example B | Example C | 2 | Example B | Example C | 2 |
| Setup 1 | 81 | 188 | 238 | — | — | — |
| Setup 2 | 17 | 61 | 168 | 7 | 11 | 24 |
| Setup 3 | 44 | 79 | 25 | 18 | 14 | 4 |

When tested with a visible camera and light source, Comparative Example B, with only a phase-reversing metal reflector, had low Brightness Retention (%) in the presence of parallel circular polarizers but high Brightness Retention (%) in the presence of orthogonal circular polarizers. Example 2, with an integrated conformal retarder and a phase-reversing metal reflector, shows the opposite effect and had high Brightness Retention (%) in the presence of parallel circular polarizers but low Brightness Retention (%) in the presence of orthogonal circular polarizers. Comparative Example C, a light directing article with a depolarizing reflector, did not show a significant difference in Brightness Retention (%) when measured for setup 2 or setup 3.

1. A light directing article comprising:
an optical element;
a conformal retarder of a predefined thickness that contours the optical element.

2. The light directing article of claim 1, wherein the optical element comprises a bead, prism, or microstructure comprising a cube corner.

3. The light directing article of claim 1, further comprising a phase reversing optical reflector;

4. The light directing article of claim 3, wherein the phase reversing optical reflector comprises a metalized layer or a dielectric stack.

5. The light directing article of claim 1, wherein the light directing article is a retroreflective article.

6. The light directing article of claim 1, wherein the conformal retarder has a substantially uniform thickness.

7. The light directing article of claim 1, wherein the conformal retarder is in direct contact with the optical element.

8. The light directing article of claim 1, wherein the conformal retarder contacts more than 5% and less than 100% of the optical element.

9. The light directing article of claim 3, wherein the phase reversing optical reflector is adjacent to the optical element and the conformal retarder is positioned on the surface of the optical element opposite from the phase reversing optical reflector.

10. The light directing article of claim 1, wherein the optical signature has a specific wavelength or polarization state.

11. The light directing article of claim 1, further comprising a plurality of optical elements forming a first region of optical elements with the conformal retarder and a second region of optical elements with the conformal retarder, wherein the conformal retarder substantially continuously contours with the optical elements at the first region of optical elements.

12. The light directing article of claim 1, further comprising a plurality of optical elements forming a first region of optical elements with the conformal retarder and a second region of optical elements with the conformal retarder, wherein the conformal retarder discontinuously contours with each of the optical elements at the first region of optical elements.

13. The light directing article of claim 1, wherein the conformal retarder is patterned to form a code, detectable by modulating different polarization states.

14. A method of making a light directing article comprising:
applying a uniform thickness of a conformal retarder to an optical element.

15. The method of claim 14, further comprising applying the conformal retarder continuously to a plurality of optical elements.
